(19) United States
(12) Patent Application Publication
(10) Pub. No.: US 2026/0298495 A1
(43) Pub. Date: Oct. 1, 2026

(54) HVAC ACTUATOR AND APPLICATION-SPECIFIC INTEGRATED CIRCUIT FOR AN HVAC ACTUATOR

(71) Applicant: BELIMO HOLDING AG, Hinwil (CN)

(72) Inventors: Silvio GROGG, Wetzikon (CH); Stephan BÖHMER, Wetzikon (CH); Martin OCHSENBEIN, Russikon (CH); Myriam TASCHI, Pfäffikon (CH); Boris LUTZ, Dürnten (CH); Roman FURRER, Eschenbach SG (CH)

(73) Assignee: BELIMO HOLDING AG, Hinwil (CN)

(21) Appl. No.: 19/480,623

(22) PCT Filed: Aug. 2, 2024
(86) PCT No.: PCT/EP2024/072056

§ 371 Date: Oct. 31, 2025

(30) Foreign Application Priority Data
Aug. 9, 2023 (CH) CH000853/2023

(51) Int. Cl. F24F 11/77; F24F 11/30

(52) U.S. Cl. CPC F24F 11/77; F24F 11/30

(57) ABSTRACT

A Heating, Ventilating, and Air Conditioning, HVAC, actuator for actuating an actuated part in an HVAC system includes an electric motor and a controller that controls the electric motor. The controller includes an Application Specific Integrated Circuit, ASIC, that includes an analog circuit and a digital circuit, the analog circuit of the ASIC generates a motor current for the electric motor, the digital circuit of the ASIC generates control signals for controlling the analog circuit, and the digital circuit of the ASIC includes a motor control circuit, a microprocessor directing the motor control circuit, and a memory having stored therein program code to control the microprocessor.

### FIELD OF THE DISCLOSURE

The present disclosure relates to an HVAC (Heating, Ventilating, and Air Conditioning) actuator and an ASIC (Application Specific Integrated Circuit) for an HVAC actuator. Specifically, the present disclosure relates to an HVAC actuator comprising an electric motor and a controller, configured to control the electric motor for actuating an actuated part in an HVAC system, and an ASIC for the HVAC actuator.

### BACKGROUND OF THE DISCLOSURE

Actuators with a controller and an electric motor are generally known in the art and used for actuating a large variety of parts in numerous applications, such as for controlling dampers or valves in HVAC systems. These HVAC actuators are typically equipped with a reduction gear for actuating a large variety of loads with required precision and accu-racy. In a typical HVAC system, a number of HVAC actuators is typically present and requires different operation parameters, e.g. moving ranges, torque, speed, and control mode. In particular, operation in position control, speed control or torque control mode may be required. In the interest of cost efficiency for installation as well as maintenance, it is desirable to use standardized HVAC actuators respectively multi-purpose HVAC actuators that can be used in a plurality of applications.

Further, in the interest of cost efficiency for manufacturing as well as maintenance and upgrade, it is desirable to provide a consistent set of control features to different sizes of HVAC actuators which comprise electrical motors of different size and driving power for a large variety of loads and applications.

### SUMMARY OF THE DISCLOSURE

It is an object of this disclosure to provide an HVAC actuator and an ASIC for an HVAC actuator. In particular, it is an object of the present disclosure to provide an HVAC actuator and an ASIC for an HVAC actuator, which HVAC actuator and ASIC do not have at least some of the disadvantages of the prior art.

According to the present disclosure, these objects are addressed by the features of the independent claims. In addition, further advantageous embodiments follow from the de-pendent claims and the description.

According to the present disclosure, the above-mentioned objects are particularly achieved in that in an HVAC actuator, for actuating an actuated part in an HVAC system, which actuator comprises an electric motor and a controller configured to control the electric motor, the controller comprises an ASIC, which includes an analog circuit and a digital circuit. The analog circuit of the ASIC is configured to generate a motor current for the electric motor. The digital circuit of the ASIC is configured to generate control signals for controlling the analog circuit. The digital circuit of the ASIC comprises a motor control circuit, a microprocessor directing the motor control circuit, and a memory unit having stored therein program code configured to control the microprocessor. For example, the program code is implemented as firmware configured to control the microprocessor.

In an embodiment, the program code is configured to control the microprocessor to operate selectively in a stand-alone mode or in an externally controlled mode. In the stand-alone mode, the microprocessor periodically repeats a sequence of steps programmed in the program code to operate the HVAC actuator. In the externally controlled mode, the microprocessor executes a subset of the steps programmed in the program code, responsive to an external microcontroller defining the subset of steps.

In an embodiment, the analog circuit comprises output terminals and is configured to provide drive signals to an external analog power stage circuit, arranged externally to the ASIC and connected to the output terminals.

In an embodiment, the motor control circuit of the ASIC is configured to implement different selectable types of motor controllers. The types of motor controllers including more than one of: motor controller using sensorless position detection, motor controller using hall sensors for position detection, and/or motor controller using a potentiometer for position detection. For example, the sensorless position detection includes back electromotive force (BEMF) position detection and rotor induction based position detection.

In an embodiment, the motor control circuit of the ASIC is configured to implement different selectable types of motor control. The types of motor control include more than one of: torque control, speed control, and/or position control. For example, the type of motor control is selected by a motor control type selector stored in a non-volatile memory unit of the controller or ASIC, respectively, and readable by the microprocessor.

In an embodiment, the program code is configured to control the microprocessor of the ASIC to implement different selectable types of control loops. The types of control loops include more than one of: air volume control, differential pressure control, and/or flow rate control. For example, the type of control loop is selected by a control loop type selector stored in a non-volatile memory unit of the controller or ASIC, respectively, and readable by the microprocessor.

In an embodiment, the digital circuit of the ASIC is configured to implement different selectable types of actuators. The types of actuators include more than one of: a modulating actuator, an open-close actuator, and/or a three-point actuator. For example, the type of actuator is selected by an actuator type selector stored in a non-volatile memory unit of the controller or ASIC, respectively, and readable by the microprocessor.

In an embodiment, the digital circuit of the ASIC is configured to process different selectable types of end-stops. The types of end-stops include more than one of: a mechanical end-stop, a limit switch end-stop, a free wheel end-stop, a sensor end-stop, and/or a position counter end-stop. For example, the type of end-stop is selected by an end-stop type selector stored in a non-volatile memory unit of the controller or ASIC, respectively, and readable by the microprocessor.

In an embodiment, the HVAC actuator comprises a non-volatile memory unit and a Near Field Communication (NFC) circuit, connected to the non-volatile memory unit and configured to store in the non-volatile memory unit configuration parameters, received from an external communication device, arranged externally to the HVAC actuator; and the digital circuit of the ASIC is configured to generate the control signals, using configuration parameters stored in the non-volatile memory unit. In alternative or additional embodiments, the configuration parameters stored in the non-volatile memory unit are received via a different communication interface than NFC, e.g. a different wireless or wired communication interface. In a further alternative embodiment, configuration parameters are changed by replacing the non-volatile memory unit, having stored therein first configuration parameters, with another non-volatile memory unit, having stored therein second configuration parameters.

For example, the configuration parameters stored in the non-volatile memory unit include at least one of: running speed, direction of rotation, communication interface address, input mode, analog input type, configuration of analog inputs and outputs for sensors and feedback, torque or force limit, end-stop positions, position control range, enable or disable auxiliary switches, switching positions of the auxiliary switches, position setpoints, fail safe positions, control mode, type of motor controller, linear or rotary actuator, position setting range, motor configuration parameters including torque limit, motor constant, number of pairs of poles, or inductivity, control parameters including controller gains for position, speed, current controller or observer, allow user to set input mode, enable storage of performance indicators, end-stop type, disable NFC communication, microprocessor control mode indicating stand-alone mode or externally controlled mode, operational parameters for specific functions including tight closing of switching threshold, number of motor turns for gear release function, hand crank speed, spring return, speed ramp, or reduced speed close to end stops, or spring return actuator configuration parameters.

In an embodiment, the HVAC actuator comprises a non-volatile memory unit and an NFC circuit, connected to the non-volatile memory unit. The digital circuit of the ASIC is configured to generate and store in the non-volatile memory unit operational performance indicators related to the performance of the electric motor. The NFC circuit is configured to read the operational performance indicators in the non-volatile memory and to transfer the operational performance indicators to the external communication device.

For example, the operational performance indicators include at least one of: total operating time, operating time in different temperatures ranges, minimum operating temperature, maximum operating temperature, maximum motor temperature, minimum operating voltage, maximum operating voltage, number of power failures, number of watchdog resets, number of motor start/stops, number of direction changes of motor, number movement onto mechanical end-stops, driving time versus torque histogram, maximum torque histogram for different position ranges, number of overload events, minimum and maximum end position displacements, supercap status, commissioning successful indicator, actuator has been powered in the field indicator, or actuator has been reconfigured in the field indicator.

In an embodiment, at least one of the non-volatile memory unit or the NFC circuit is integrated in the ASIC.

In an embodiment, the program code is configured to control the microprocessor to reject a write request received from the external communication device, if the write request is directed to writing into the non-volatile memory unit a data value which does not differ from the data value presently stored in the non-volatile memory unit, or if the write request exceeds a number of allowable write operations, e.g. in a defined duration of time. The number of allowable write operations is increased over time up to a maximum number of write operations. For example, the number of allowable write operations is being increased by the microprocessor, e.g. periodically.

In an embodiment, the ASIC comprises an interface configured to connect to the digital circuit of the ASIC at least one of: a temperature sensor, a flow sensor, a pressure sensor, a hall sensor, an external further ASIC, arranged externally to the ASIC, an external microcontroller, arranged externally to the ASIC, or a supercap module, arranged externally to the ASIC.

In an embodiment, the digital circuit comprises a read/write memory unit accessible for the microprocessor, and the program code is configured to control the microprocessor to exchange data between the read/write memory unit and the external microcontroller via the interface.

In an embodiment, the interface comprises at least one of: a serial communication line interface and/or a parallel communication bus interface.

In an embodiment, the HVAC actuator comprises a printed circuit board, and the electric motor and the controller are arranged on the printed circuit board.

In an embodiment, the ASIC comprises a charge pump controller configured to provide power to the HVAC actuator.

In addition to the HVAC actuator, the present disclosure also relates to an Application Specific Integrated Circuit (ASIC) for an HVAC actuator. The ASIC comprises an analog circuit and a digital circuit. The analog circuit of the ASIC is configured to generate a motor current for the electric motor of the HVAC actuator. The digital circuit of the ASIC is configured to generate control signals for controlling the analog circuit. The digital circuit of the ASIC comprises a motor control circuit, a microprocessor directing the motor control circuit, and a memory unit having stored therein program code configured to control the microprocessor.

Further embodiments and features of the ASIC are described above in connection with the ASIC of the HVAC actuator.

### BRIEF DESCRIPTION OF THE DRAWINGS

The present disclosure will be explained in more detail, by way of example, with reference to the drawings in which:

FIG. 1 shows a block diagram illustrating schematically an HVAC actuator with a controller, comprising an ASIC with an analog circuit and a microprocessor, for controlling the HVAC actuator's electric motor to actuate an actuated part in an HVAC system.

FIG. 2 shows a block diagram illustrating schematically an HVAC actuator with a controller, comprising an ASIC with an analog circuit and a microprocessor, whereby the analog circuit comprises output terminals to provide drive signals to an external analog power stage driving the HVAC actuator's electric motor.

FIG. 3 shows a block diagram illustrating schematically an HVAC actuator with a controller, comprising an ASIC with an analog circuit, a microprocessor, a non-volatile memory unit for storing configuration parameters for the ASIC, and an optional communication interface for receiving the configuration parameters from an external device.

FIG. 4 shows a block diagram illustrating schematically an HVAC actuator with a controller comprising an ASIC with an interface for connecting external devices such as temperature sensors, flow sensors, pressure sensors, hall sensors, an external ASIC, an external microcontroller, and/or a supercap module.

FIG. 5 shows a block diagram illustrating schematically data and signal flow associated with an ASIC of an HVAC actuator, which ASIC comprises an analog circuit and a digital circuit with a microprocessor.

FIG. 6 shows a block diagram illustrating schematically an HVAC actuator with a printed circuit board having arranged thereon the HVAC actuator's electric motor and a controller with ASIC for controlling the electric motor.

FIG. 7 shows a block diagram illustrating schematically an ASIC for a controller of an HVAC actuator, the ASIC comprising an analog circuit and a microprocessor, for controlling the HVAC actuator's electric motor.

FIG. 8 shows a block diagram illustrating schematically an ASIC for a controller of an HVAC actuator, the ASIC comprising an analog circuit and a microprocessor, whereby the analog circuit comprises output terminals to provide drive signals to an external analog power stage driving the HVAC actuator's electric motor.

FIG. 9 shows a block diagram illustrating schematically an ASIC for a controller of an HVAC actuator, the ASIC comprising an analog circuit, a microprocessor, a non-volatile memory unit for storing configuration parameters for the ASIC, and an optional communication interface for receiving the configuration parameters from an external device.

FIG. 10 shows a block diagram illustrating schematically an ASIC for a controller of an HVAC actuator, the ASIC comprising an interface for connecting external devices such as temperature sensors, flow sensors, pressure sensors, hall sensors, an external ASIC, an external microcontroller, or a supercap module.

FIG. 11 shows a flow diagram illustrating a sequence of steps for operating the ASIC's microprocessor selectively in a stand-alone mode or in an externally controlled mode.

FIG. 12 shows a flow diagram illustrating a sequence of steps executed by the ASIC's microprocessor in a stand-alone mode or in an externally controlled mode.

FIG. 13 shows a flow diagram illustrating a sequence of steps for operating the ASIC's microprocessor in a mode of operation based on stored configuration parameters.

FIG. 14 shows a flow diagram illustrating a sequence of steps for the ASIC's microprocessor controlling write requests directed to a non-volatile memory.

### DETAILED DESCRIPTION OF THE EMBODIMENTS

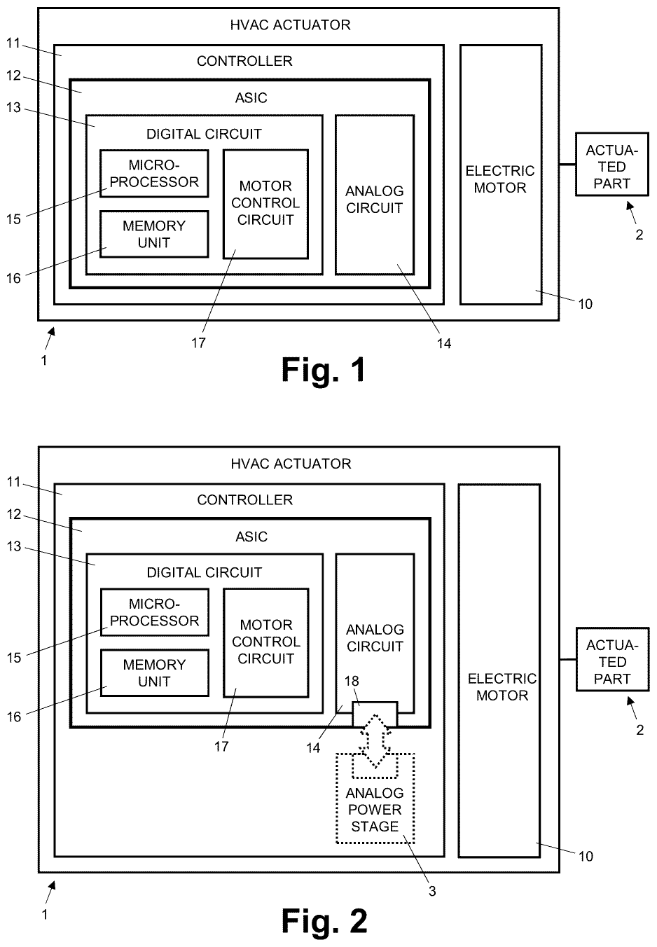

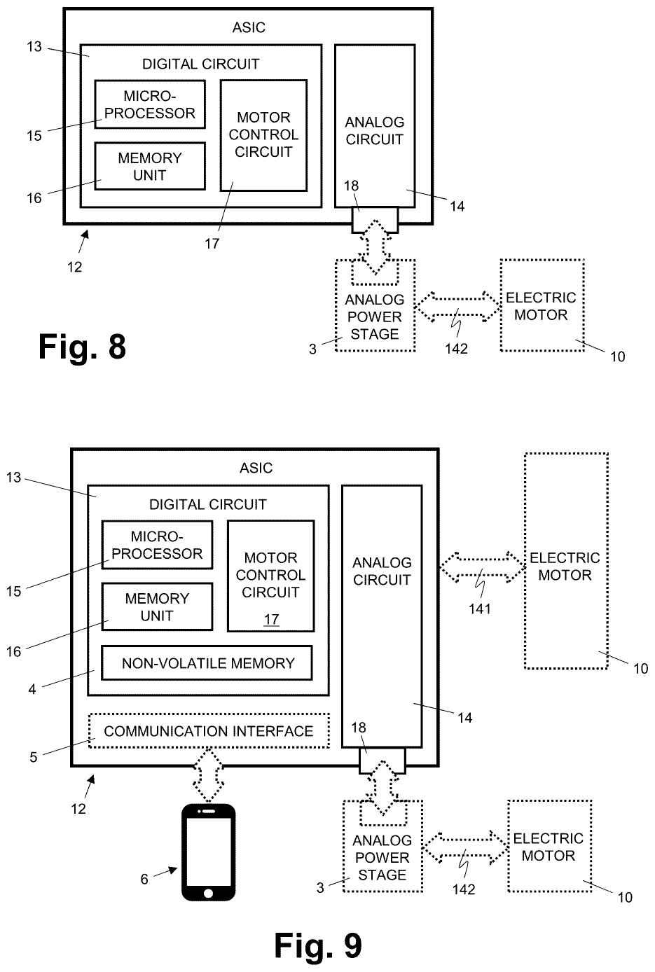

In FIGS. 1-6, reference numeral 1 refers to an HVAC actuator. As illustrated in FIGS. 1-6, the HVAC actuator 1 comprises an electric motor 10 and a controller 11. In a pre-ferred embodiment, the electric motor 10 is a brushless direct current motor (BLDC), i.e. a brushless permanent-magnet motor. As illustrated schematically in FIGS. 1-5, the HVAC actuator 1 is configured to actuate an actuated part 2 in an HVAC system. For example, the actuated part 2 is a valve or a damper for adjusting the flow of fluid in a pipe or duct of the HVAC system. As further illustrated in FIGS. 1-6, the controller 11 comprises an ASIC 12, which is also shown as a separate component in FIGS. 7-10.

As illustrated in FIGS. 1-10, the ASIC 12 comprises a digital circuit 13 and an analog circuit 14.

The analog circuit 14 comprises a power stage circuit configured to generate the motor current 141 for the electric motor 10. The power stage circuit comprises three half bridges for energizing the three phases of the electric motor 10. The power stage generates the phase currents for energizing the three phases of the electric motor 10. For example, the power stage circuit is configured to energize the phases by way of pulse width modulation (PWM) in a sinusoidal manner. In an embodiment, the analog circuit 14 generates an identification signal for indicating to the digital circuit 13 the version or power level of the analog circuit 14, e.g. a 200 W power stage or a 600 W power stage. Thereby, the same digital circuit 13 may be used for different builds of the analog circuit 14.

The digital circuit 13 is configured to generate control signals for controlling the analog circuit 14. As illustrated in FIGS. 1-10, the digital circuit 13 comprises a microprocessor 15, a memory unit 16, and a motor control circuit 17. The memory unit 16 has stored therein program code configured to control the microprocessor 15. The program code constitutes the firmware for the ASIC 12 or controller 11, respectively. The microprocessor 15 is configured to direct the motor control circuit 17. In other words, the program code stored in the memory unit 16 controls the microprocessor 15 to direct the motor control circuit 17. The motor control circuit 17 generates the control signals for the analog circuit 14. The motor control circuit 17 is configured to implement different selectable/configurable types of motor control, e.g. position control, speed control, and/or torque control. The microprocessor 15 generates the setpoint values for the motor control circuit 17. The setpoint values depend on the selected/configured type of motor control. More specifically, depending on whether position control, speed control, or torque control is selected/configured as the motor control type, the microprocessor 15 generates for the motor control circuit 17 setpoint values for position, speed, or torque. The microprocessor 15 further provides to the motor control circuit 17 limit values, depending on the selected/configured type of motor control, for example power limit, speed limit and/or torque limit for position control, or power limit and/or speed limit for torque control.

Depending on the selected/configured type of motor control, the motor control circuit 17 operates as a position controller, a speed controller, or a torque controller, using the respective setpoints and limits from the microprocessor 15. The motor control circuit 17 controls position, speed, or torque by generating the control signals for the analog circuit 14, using three-phase pulse width modulation (PWM). The motor control circuit 17 further provides feedback to the microprocessor 15 regarding current position, speed, and/or torque of the electric motor 10. While the microprocessor 15 executes a sequence of supervisory functions or steps, e.g. at a rate of several milliseconds, the motor control circuit 17 performs time critical real-time functions, at a comparably higher speed, e.g. at a rate of several microseconds. The motor control circuit 17 is further configured to implement different selectable/configurable types of motor controllers, e.g. a motor controller using sensorless position detection, a motor controller using hall sensors for position detection, and/or a motor controller using a potentiometer for position detection.

As indicated schematically by dashed lines in FIGS. 2-5 and 8-10, the ASIC 12 is configured to be combined with an external analog power stage 3, e.g. in cases where the power stage of the built-in analog circuit 14 does not provide sufficient power for the electric motor 10 being used. For these cases, the analog circuit 14 of the ASIC 12 comprises output terminals 18 and is configured to provide drive (control) signals to an external analog power stage circuit 3 connected to the output terminals 18. The external analog power stage circuit 3 is configured to generate the motor current 142 for the electric motor 10. Typically, as outlined above in connection with analog circuit 14, the external analog power stage circuit 3 comprises three half bridges for energizing the three phases of the electric motor 10. It should be noted that in cases where, the built-in power stage of the ASIC 12 is used, the output terminals 18 can be reconfigured and used as digital output terminals for outputting other values or signals from the digital circuit 13. For example, the output of a charge pump controller (integrated in the ASIC 12) can be directed to the output terminals 18.

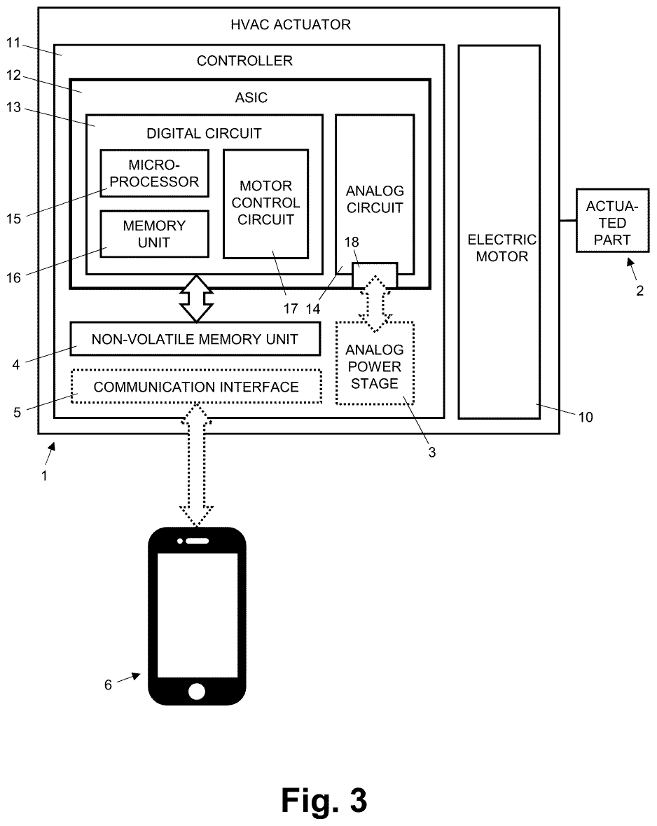

In FIGS. 3-5 and 9-10, reference numeral 4 refers to a non-volatile memory unit, e.g. an Electrically Erasable Programmable Read-Only Memory (EEPROM). The non-volatile memory unit 4 is configured to store configuration parameters for the HVAC actuator 1 and its controller 11. As illustrated schematically in FIGS. 3-5 and 9-10, in some embodiments the controller 11 further comprises a communication interface 5 connected to the non-volatile memory unit 4, e.g. a Near Field Communication (NFC) circuit. In these embodiments, an external mobile communication device 6, such as a mobile phone, a smart watch, or a tablet or laptop computer, can access the non-volatile memory unit 4 via the communication interface 5. Particularly, the external communication device 6 can read and write configuration parameters from and to the non-volatile memory unit 4. The person skilled in the art will understand that other communication interfaces, particularly wired communication interfaces and/or communication buses, can also be provided and used to access the non-volatile memory unit 4.

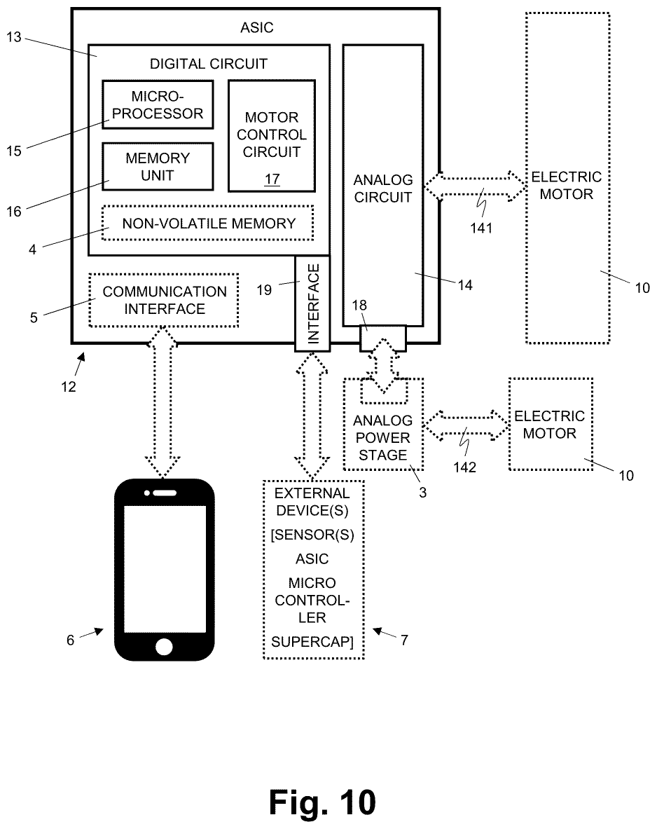

As illustrated schematically in FIGS. 9 and 10, in some embodiments, the non-volatile memory unit 4 and/or the communication interface 5, particularly the NFC circuit, is/are integrated in the ASIC 12. Alternatively, the communication interface 5, particularly the NFC circuit, is connected to the ASIC 12 via an I2C (serial) interface.

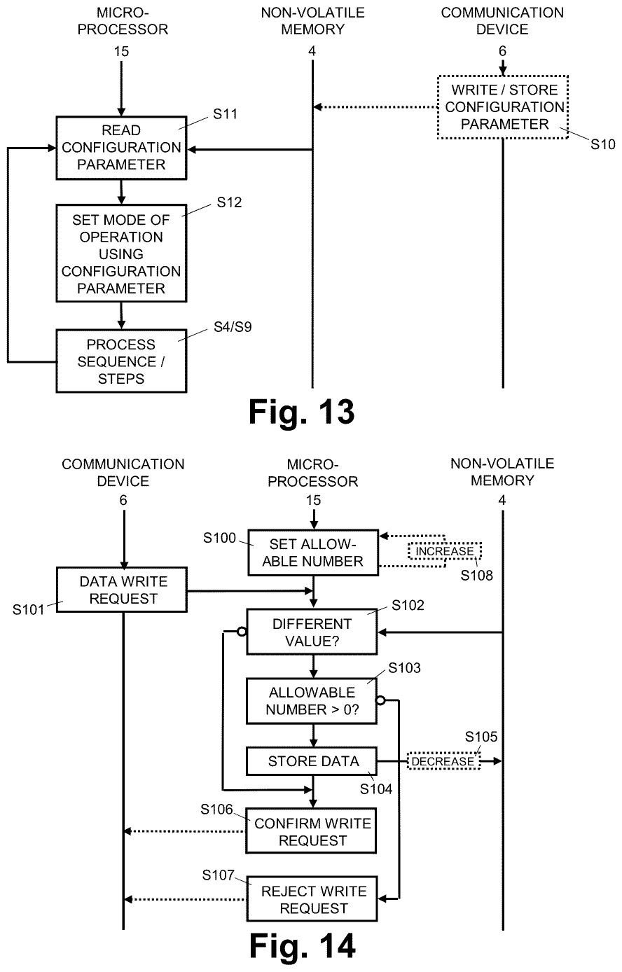

FIG. 13 illustrates an exemplary sequence of steps for writing and storing configuration parameters in the non-volatile memory unit 4, and for the controller 11 using the stored configuration parameters.

In step S10, the communication device 6 generates and transmits a write request for a configuration parameter via communication interface 5 to the controller 11. Depending on the embodiment, the write request is processed directly by the communication interface 5 storing the received configuration parameter in the non-volatile memory unit 4, or the write request is processed by the microprocessor 15, as will be described in more detail below with reference to FIG. 14. Alternatively, configuration parameters are written into the non-volatile memory unit 4 in a writing device separate from the HVAC actuator 1 and the non-volatile memory unit 4 is subsequently inserted in and connect to the HVAC actuator 1 and its controller 11.

In step S11, the microprocessor 15 reads configuration parameters from the non-volatile memory unit 4. The microprocessor 15 reads the majority of the configuration parameters at start-up (“booting”) time. Depending on the embodiment and/or configuration, restart or “reboot” is triggered by a power reset or in response to writing the configuration parameters. Per NFC communication, the configuration parameters can be written via the NFC circuit to the non-volatile memory unit 4 in powered or non-powered (power-less) state of the HVAC actuator 1. In step S12, the microprocessor 15 sets various modes of operation depending on and using the configuration parameters read from the non-volatile memory unit 4, as mentioned above and as will be further explained below in more detail.

It is pointed out here that writing configuration parameters via the NFC circuit to the non-volatile memory unit 4 (e.g. an EEPROM) in non-powered (power-less) mode has the advantage that the HVAC actuator 1 can be configured, e.g. with field configurable parameters, prior to its installation, before it is mounted and connected to electrical power, enabling faster and more flexible configuration of the HVAC actuator 1. In step S4/S9, the microprocessor 15 operates the HVAC actuator 1 in adherence to the modes of operation set in step S12, as mentioned above and as will be further explained below in more detail.

FIG. 14 illustrates an exemplary sequence of steps executed by the microprocessor 15 for processing a write request received via communication interface 5 from an external communication device 6.

In step S100, an allowable number of write operations is set as a “credit”. For example, the initial value for the allowable number of write operations is read by the microprocessor 15 as a configuration parameter from the non-volatile memory 4.

In optional step S108, the microprocessor 15 adjusts the allowable number of write operations, i.e. the “credit”, to increase the number of allowable write operations, e.g. up to a set maximum number of write operations, such as to renew or refresh the “credit” over time. For example, the microprocessor 15 executes step S108 periodically or after defined time intervals, which may vary in duration over time.

In step S101, the communication device 6 generates and transmits the write request for a configuration parameter via communication interface 5 to the controller 11 where it is received and processed by the microprocessor 15.

In step S102, the microprocessor 15 checks whether the received write request is directed to writing into the non-volatile memory unit 4 a data value, which does not differ from the data value presently stored in the non-volatile memory unit 4. If the received write requests would not alter the data value already stored in the non-volatile memory unit 4, processing continues in step S106 where the write request is confirmed; otherwise, processing continues in step S103.

In step S103, the microprocessor 15 checks whether there is still “credit”, i.e. whether the allowable number of write operations is still positive, and, thus, the received write request would not exceed the allowable number of write operations. If the received write requests would not exceed the allowable number of write operations, processing continues in step S104; otherwise, processing continues in step S107 where the write request is rejected.

In step S104, the microprocessor 15 stores the received data value in the non-volatile memory unit 4. In step S105, the microprocessor 15 decreases the allowable number of write operations, i.e. the “credit” is reduced. Subsequently, in step S106, the microprocessor 15 confirms the write request.

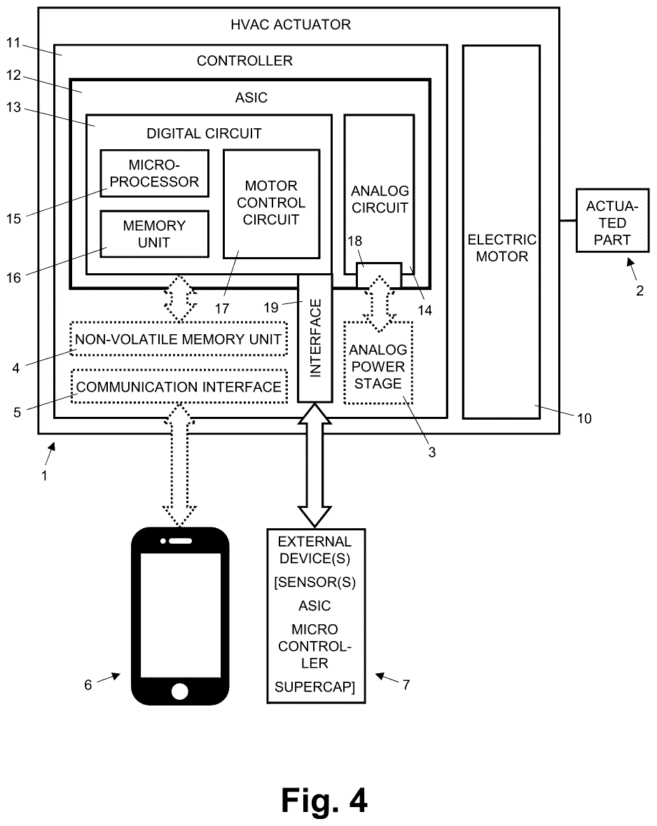

In FIGS. 4-5 and 10, reference numeral 19 refers to an interface for connecting external devices to the digital circuit of the ASIC 12. The interface 19 comprises a serial communication line interface and/or a parallel communication bus interface. The interface 19 further comprises analog interfaces, including analog input terminals for receiving analog setpoint signals, potentiometer signals for position control, analog sensor signals, e.g. temperature sensor signals, and analog output terminals, e.g. for providing analog feedback signals, e.g. for a superior control system. The interface 19 is configured to connect to the ASIC 12 external devices, arranged externally to the ASIC 12 of the HVAC actuator 1, such as temperature sensors, flow sensors, pressure sensors, hall sensors, further external ASICs, an external microcontroller 7, and/or a supercap module. Interface 19 is further configured to receive external setpoint values for the HVAC actuator 1, e.g. from a user terminal or a building control or management system. In an embodiment, interface 19 comprises a serial MP-bus slave interface configured to receive MP commands and transmit MP responses, and activate/deactivate the MP bus watchdog. In a further embodiment, interface 19 is configured to perform as a MP master gateway, receiving and forwarding master signals from an MP bus. For example, interface 19 is configured to act as an MP bus relay, which receives and forwards incoming MP packets via the wired actuator interface from and to an external microcontroller 7. This makes it possible for the external microcontroller 7 to receive, filter, and transmit MP packets without having to implement its own driver and analog circuit for MP-bus communication. For example, the functions of receiving, interpreting and executing MP commands addressed to the HVAC actuator 1, as well as returning replies, are implemented in the digital circuit of the ASIC 12 or its firmware, respectively. It is noted here that the digital circuit of the ASIC 12 or its firmware, respectively, are configured to operate as MP bus master or MP bus slave; correspondingly, the external microcontroller 7 will operate as MP bus slave or MP bus master. In an embodiment, the communication via NFC in powered mode is done using the MP protocol, e.g. for configuring, commissioning and monitoring the HVAC actuator 1 and its ASIC.

In an embodiment, the ASIC 12 further comprises a charge pump controller (not illustrated) configured to provide power to the HVAC actuator 1.

The microprocessor 15 or the program code, respectively, is configured to exchange data between the memory unit 16 and the external microcontroller 7, or other external devices, via the interface 19. In other words, the microprocessor 15 is configured to exchange data with the external microcontroller 7, or other external devices, via the memory unit 16 and the interface 19.

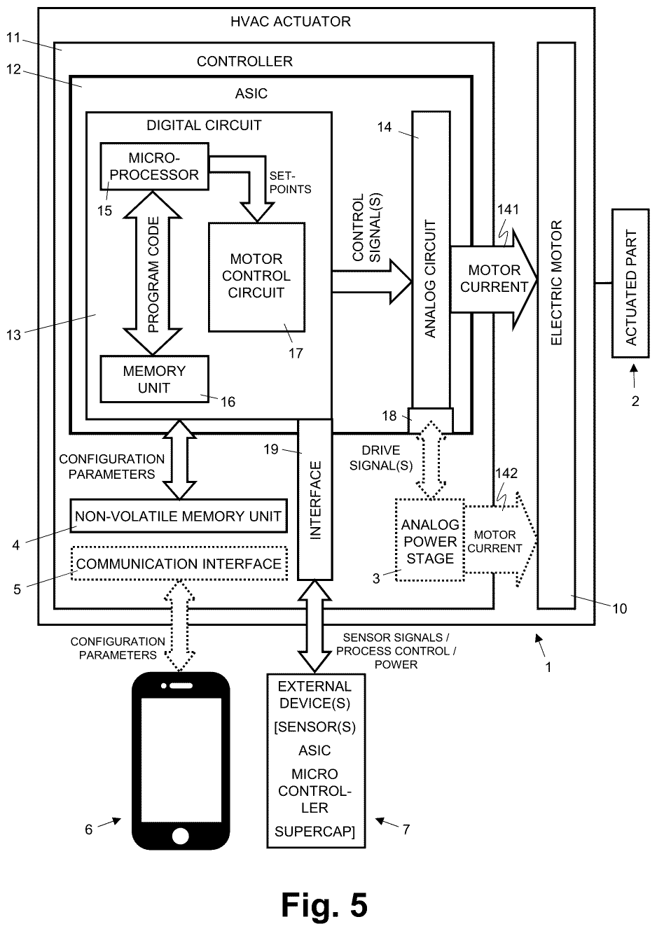

FIG. 5 shows an overview of some data and signal flow associated with the ASIC 12. As illustrated in FIG. 5, the microprocessor 15 of the ASIC 12 obtains and is controlled by program code stored in the memory unit 16 of the ASIC 12. Controlled by the program code, the microprocessor 15 reads configuration parameters from the non-volatile memory unit 4 of the controller 11, and sets an operating mode and operates in adherence to the configuration parameters. Controlled by the program code, the microprocessor 15 further obtains data and signal values via the interface 19 from external devices 7, such as temperature values from a temperature sensor, flow rate values from a flow sensor, pressure values from a pressure sensor, motor position values from a potentiometer or hall sensor, synchronization data and/or signals from an external microcontroller, etc. Controlled by the program code, the microprocessor 15 further generates setpoints for the motor control circuit 17, e.g. using some of the data and signal values from external devices 7. The motor control circuit 17 generates control signals for the analog circuit 14 and/or drive (control) signals for an analog power stage 3. Responsive to the control signals or drive signals from the motor control circuit 17, the analog circuit 14 or the analog power stage 3, respectively, generate motor currents 141, 142 for the electric motor 10.

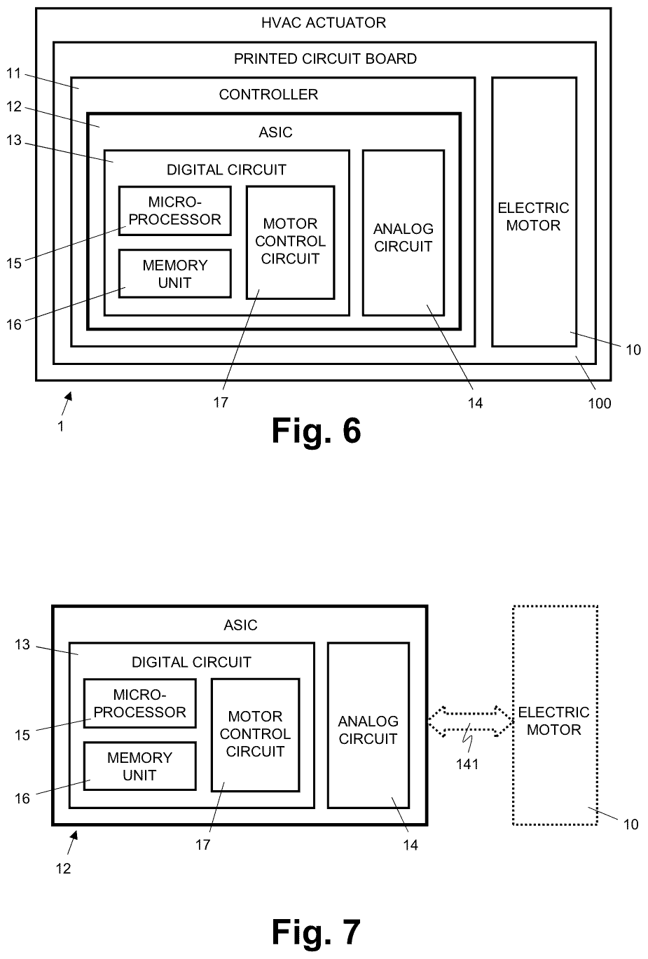

FIG. 6, illustrates an exemplary configuration where the controller 11, including the ASIC 12, and the electric motor 10 are arranged on a common printed circuit board 100.

The following paragraphs describe different examples of configuration parameters and their use by the controller 11 or microprocessor 15, respectively.

As already mentioned above, the configuration parameter directed to the type of motor controller determines whether the motor control circuit 17 operates as a motor controller using sensorless position detection, a motor controller using hall sensors for position detection, or a motor controller using a potentiometer for position detection. The sensorless position detection includes back electromotive force (BEMF) position detection and rotor induction based position detection, for example. The microprocessor 15 operates in accordance with the selected/configured type of motor controller.

The configuration parameter directed to the type of motor control determines whether the motor control circuit 17 operates using position control, speed control, or torque control. The microprocessor 15 operates in accordance with the selected/configured type of motor control.

A further configuration parameter is directed to the type of control loop and determines whether the microprocessor 15 executes air volume control, differential pressure control, or flow rate control. The microprocessor 15 processes received setpoints and data/signal values in accordance with the selected/configured type of control loop, e.g. as an air flow value, a differential pressure value, or a flow rate value, for example.

A further configuration parameter is directed to the type of actuator and determines whether the digital circuit 13, particularly the microprocessor 15, operates the electric motor 10 as a modulating actuator, an open-close actuator, or a three point actuator, for example. The microprocessor 15 processes received setpoints and data/signal values in accordance with the selected/configured type of actuator.

A further configuration parameter is directed to the type of end-stops and determines whether the digital circuit 13, particularly the microprocessor 15, implements and processes a mechanical end-stop, a limit switch end-stop, a free wheel end-stop, a sensor end-stop, or a position counter end-stop. Depending on the selected/configured type of end-stop, the motor control circuit 17 determines and provides different feedback signals, which are processed by the microprocessor 15. For example, for a mechanical end-stop, the feedback signals include rotation indicator and torque limit indicator; for a free wheel end-stop, the feedback signals include a free run indicator; for a sensor end-stop, the feedback signals include a sensor value; and for a position counter end-stop, the feedback signals include a position or counter value.

Further configuration parameters are directed to the operation of the HVAC actuator 1 or its electric motor 10 and other components. For example, the operational configuration parameters include running speed, direction of rotation, communication interface address, input mode, analog input type, configuration of analog inputs and outputs for sensors and feedback, torque or force limit, end-stop positions, position control range, enable or disable auxiliary switches, switching positions of the auxiliary switches, position setpoints, fail safe positions, control mode, type of motor controller, linear or rotary actuator, position setting range, motor configuration parameters including torque limit, motor constant, number of pairs of poles, or inductivity, control parameters including controller gains for position, speed, current controller or observer, allow user to set input mode, enable storage of performance indicators, end-stop type, disable NFC communication, microprocessor control mode indicating stand-alone mode or externally controlled mode, operational parameters for specific functions including tight closing of switching threshold, number of motor turns for gear release function, hand crank speed, spring return, speed ramp, or reduced speed close to end stops, or spring return actuator configuration parameters.

A further configuration parameter, the operating mode configuration parameter, is directed to the mode of operation of the microprocessor 15 itself. The microprocessor 15 or the program code, respectively, is configured to operate in either a stand-alone mode or an externally controlled mode.

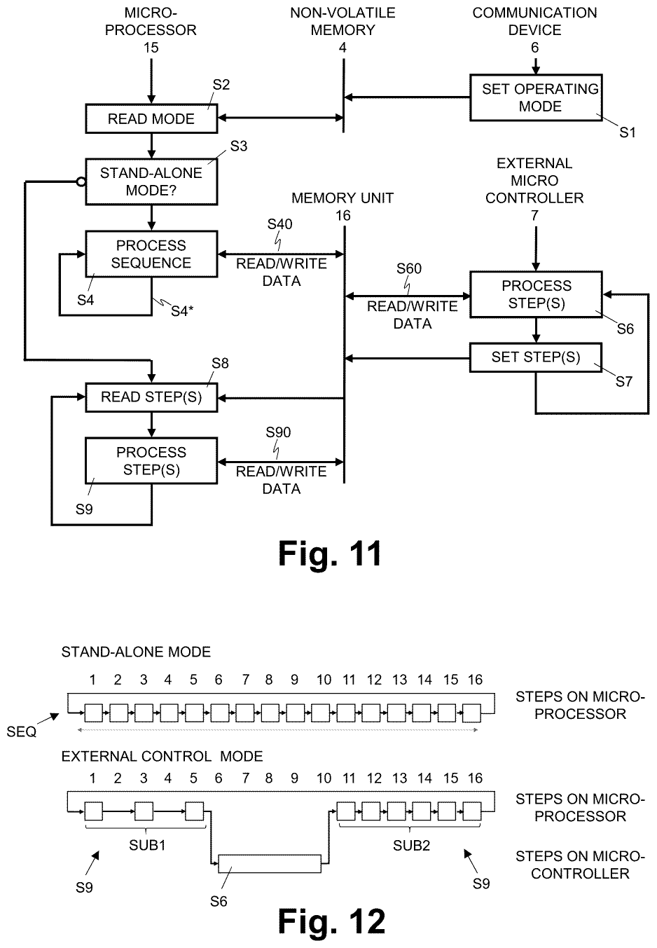

As illustrated in the upper part of FIG. 12, in the stand-alone mode, the microprocessor 15 implements a state machine and executes repeatedly a fixed sequence of steps SEQ [1 2 3 4 5 6 7 8 9 10 11 12 13 14 15 16] implemented in the program code stored in the non-volatile memory unit 4 (as indicated in FIG. 11 by reference numeral S4).

In the externally controlled mode, illustrated in FIG. 12 (lower part), the microprocessor 15 executes one or more subsets SUB1, SUB2 of these steps/tasks (as indicated in FIGS. 11 and 12 by reference numeral S9), which are defined by an external microcontroller. After executing a subset of steps, e.g. SUB1 or SUB2, the microprocessor 15 relinquishes control to the external microcontroller, which executes its own steps (as indicated in FIGS. 11 and 12 by reference numeral S6) and may define a further subset of steps to be executed by the microprocessor 15 (as indicated in FIG. 11 by reference numeral S7). In the example of FIG. 12, the external microcontroller defines for the microprocessor 15 to execute the subsets SUB1 and SUB2 with the steps [1 3 5] and [11 12 13 14 15 16] of the program code stored in the non-volatile memory unit 4. More specifically, in step S7 (FIG. 11), the external microcontroller defines a first subset SUB1 with steps [1 3 5] in the memory unit 16 and, in step S9, the microprocessor 15 executes the first subset SUB1 with steps [1 3 5] defined by the external microcontroller and relinquishes control to the external microcontroller. Subsequently, in step S6, the external microcontroller executes its own steps and in step S7 sets a second subset SUB2 with steps [11 12 13 14 15 16]. Regaining control, the microprocessor 15 executes the second subset SUB2 with steps [11 12 13 14 15 16] defined by the external microcontroller and again relinquishes control to the external microcontroller. In this way, there may be several changes of control between the microprocessor 15 and the external microcontroller within one control loop.

For example, the sequence of steps SEQ executed by the microprocessor 15 includes: reading digital inputs; obtaining current operational values of the electric motor 10, e.g. motor position, torque, actuator position; reading external setpoint values for the HVAC actuator 1, e.g. via interface 19; determining whether there is an exception situation, such as power failure, synchronization failure, gear problem, etc.; processing of controller input signals, e.g. inverting; processing of actuator functions, such as closing tightly, anti-sticking function, overload detection, breaking function, etc.; generating setpoint values for the motor control circuit 17; generating and outputting feedback signals, e.g. via interface 19, e.g. the current motor position, e.g. for a higher level control system, such as a building control system; transfer of the setpoints to the motor control circuit 17; and outputting digital values.

Essentially, in the stand-alone mode the microprocessor 15 executes repeatedly the fixed sequence of steps SEQ for generating the setpoints for the motor control circuit 17. In the stand-alone mode, a scheduler of the ASIC 12 is active and manages execution of the complete sequence SEQ of consecutive steps in a fixed order, e.g. with repetition every 100 ms. In the externally controlled mode, on the other hand, the microprocessor 15 does not execute the complete sequence SEQ of steps for generating the setpoints, but the sequence is split between the microprocessor 15 and the external microcontroller 7. In other words, some steps, e.g. subset SUB, are performed by the microprocessor 15 while other (different) steps are performed by the external microcontroller 7. In the externally controlled mode, the scheduler of the ASIC 12 is deactivated and the external microcontroller 7 is in charge/control of the timing/scheduling. This makes it possible, for instance, to execute control loops, which require more processing power on the external microcontroller 7. The microprocessor 15 and the external microcontroller 7 use a shared (common) data pool in the memory unit 16 for exchanging data, for example the volatile memory of the microprocessor 15. It should be noted that individual steps from the sequence are atomic, i.e. they cannot be partially executed.

FIG. 11 illustrates an exemplary sequence of steps for operating the microprocessor 15 in stand-alone or externally controlled modes.

In step S1, the operating mode configuration parameter is set in the non-volatile memory unit 4 to stand-alone mode, e.g. by communication device 6 or by another configuration device. For example, the operating mode is set during manufacturing configuration via NFC communication or via wired communication.

In step S2, the microprocessor 15 reads the operating mode configuration parameter stored in the non-volatile memory unit 4. Reading the operating mode is performed during startup or restart, respectively, of the HVAC actuator 1.

In step S3, the microprocessor 15 checks whether the operating mode (configuration parameter) is set to stand-alone mode.

If the operating mode (configuration parameter) is set to stand-alone mode, the microprocessor 15 continues in step S4 by processing the fixed sequence of steps SEQ [1 2 3 4 5 6 7 8 9 10 11 12 13 14 15 16] of the program code stored in the memory unit 16. As indicated schematically in FIG. 11, in step(s) S40, during processing the fixed sequence of steps SEQ, the microprocessor 15 reads and writes working data in the memory unit 16. As indicated schematically by loop S4*, the sequence of steps SEQ is executed repeatedly, e.g. at a set interval, e.g. every 100 ms. Otherwise, if the operating mode (configuration parameter) is set to externally controlled mode, the microprocessor 15 continues processing in step S8.

In step S6, the external microcontroller 7 processes its own steps and tasks, and, in step S7, sets the steps to be executed by the microprocessor 15, e.g. by setting these steps in the memory unit 16. As indicated schematically in FIG. 11, in step(s) S60, during processing its steps, the external microcontroller 7 reads and writes working data in the memory unit 16. Particularly, the external microcontroller 7 reads and writes working data in memory shared with the microprocessor 15 for cooperating with the microprocessor 15. Thus, the external microcontroller 7 writes working data in the memory unit 16 for use in subsequent steps executed by the external microcontroller 7 and/or by the microprocessor 15. The external microcontroller 7 further reads working data from the memory unit 16 as previously stored by the microprocessor 15 (see steps S9 and S90).

In step S8, the microprocessor 15 reads the subset (e.g. SUB1 or SUB2) of steps to be processed, e.g. as set by the microcontroller 7 in the memory unit 16.

In step S9, the microprocessor 15 executes the subset of steps, e.g. SUB1 or SUB2, as set by the microcontroller 7. As indicated schematically in FIG. 11, in step(s) S90, during processing the subset of steps, e.g. SUB1 or SUB2, the microprocessor 15 reads and writes working data in the memory unit 16. Particularly, the microprocessor 15 reads and writes working data in memory shared with the external microcontroller 7 for cooperating with the external microcontroller 7. Thus, the microprocessor 15 reads working data from the memory unit 16 as previously stored by the external microcontroller 7 and writes working data in the memory unit 16 for use in subsequent steps executed by the external microcontroller 7 (see steps S6 and S60) and/or the microprocessor 15 (see steps S9 and S90).

In addition to reading configuration parameters stored in the non-volatile memory unit 4, the microprocessor 15 or the program code, respectively, is further configured to store operational performance indicators in the non-volatile memory unit 4. The operational performance indicators can be read by an external communication device 6 via communication interface 5, for example wireless via NFC. For example, the operational performance indicators relate to the performance of the electric motor. For example, the operational performance indicators and include one or more of: total operating time, operating time in different temperatures ranges, minimum operating temperature, maximum operating temperature, maximum motor temperature, minimum operating voltage, maximum operating voltage, number of power failures, number of watchdog resets, number of motor start/stops, number of direction changes of motor, number movement onto mechanical end-stops, driving time versus torque histogram, maximum torque histogram for different position ranges, number of overload events, minimum and maximum end position displacements, supercap status, commissioning successful indicator, actuator has been powered in the field indicator, or actuator has been reconfigured in the field indicator.

It should be noted that, in the description, the sequence of the steps has been presented in a specific order, one skilled in the art will understand, however, that the order of at least some of the steps could be altered, without deviating from the scope of the disclosure.

1. A Heating, Ventilating, and Air Conditioning, HVAC, actuator for actuating an actuated part in an HVAC system, the HVAC actuator comprising an electric motor and a controller configured to control the electric motor, the controller comprising an Application Specific Integrated Circuit, ASIC, wherein the ASIC includes an analog circuit and a digital circuit, the analog circuit of the ASIC is configured to generate a motor current for the electric motor, the digital circuit of the ASIC is configured to generate control signals for controlling the analog circuit and the digital circuit of the ASIC comprises a motor control circuit a microprocessor directing the motor control circuit and a memory unit having stored therein program code configured to control the microprocessor.

2. The HVAC actuator of claim 1, wherein the program code is configured to control the microprocessor to operate selectively in a stand-alone mode or in an externally controlled mode, whereby in the stand-alone mode, the microprocessor periodically repeats a sequence of steps programmed in the program code to operate the HVAC actuator, and in the externally controlled mode, the microprocessor executes a subset of the steps programmed in the program code, responsive to an external microcontroller defining the subset of steps.

3. The HVAC actuator of claim 1, wherein the analog circuit comprises output terminals and is configured to provide drive signals to an external analog power stage circuit, arranged externally to the ASIC and connected to the output terminals

4. The HVAC actuator of claim 1, wherein the motor control circuit of the ASIC is configured to implement different selectable types of motor controllers, the types of motor controllers including more than one of: motor controller using sensorless position detection, motor controller using hall sensors for position detection, or motor controller using a potentiometer for position detection.

5. The HVAC actuator of claim 1, wherein the motor control circuit of the ASIC is configured to implement different selectable types of motor control, the types of motor control including more than one of: torque control, speed control, or position control.

6. The HVAC actuator of claim 1, wherein the program code is configured to control the microprocessor of the ASIC to implement different selectable types of control loops, the types of control loops including more than one of: air volume control, differential pressure control, or flow rate control.

7. The HVAC actuator of claim 1, wherein the digital circuit of the ASIC is configured to implement different selectable types of actuators, the types of actuators including more than one of: a modulating actuator, an open-close actuator, or a three point actuator.

8. The HVAC actuator of claim 1, wherein the digital circuit of the ASIC is configured to process different selectable types of end-stops, the types of end-stops including more than one of: a mechanical end-stop, a limit switch end-stop, a free wheel end-stop, a sensor end-stop, or a position counter end-stop.

9. The HVAC actuator of claim 1, wherein the HVAC actuator comprises a non-volatile memory unit and a Near Field Communication, NFC, circuit, connected to the non-volatile memory unit and configured to store in the non-volatile memory unit configuration parameters, received from an external communication device, arranged externally to the HVAC actuator; and the digital circuit of the ASIC is configured to generate the control signals, using configuration parameters stored in the non-volatile memory unit.

10. The HVAC actuator of claim 9, wherein the configuration parameters include at least one of: running speed, direction of rotation, communication interface address, input mode, analog input type, configuration of analog inputs and outputs for sensors and feedback, torque or force limit, end-stop positions, position control range, enable or disable auxiliary switches, switching positions of the auxiliary switches, position setpoints, fail safe positions, control mode, type of motor controller, linear or rotary actuator, position setting range, motor configuration parameters including torque limit, motor constant, number of pairs of poles, or inductivity, control parameters including controller gains for position, speed, current controller or observer, allow user to set input mode, enable storage of performance indicators, end-stop type, disable NFC communication, microprocessor control mode indicating stand-alone mode or externally controlled mode, operational parameters for specific functions including tight closing of switching threshold, number of motor turns for gear release function, hand crank speed, spring return, speed ramp, or reduced speed close to end stops, or spring return actuator configuration parameters.

11. The HVAC actuator of claim 1, wherein the HVAC actuator comprises a non-volatile memory unit and a Near Field Communication, NFC, circuit, connected to the non-volatile memory unit; the digital circuit of the ASIC is configured to generate and store in the non-volatile memory unit operational performance indicators related to the performance of the electric motor; and the NFC circuit is configured to read the operational performance indicators in the non-volatile memory and to transfer the operational performance indicators to the external communication device.

12. The HVAC actuator of claim 11, wherein the operational performance indicators include at least one of: total operating time, operating time in different temperatures ranges, minimum operating temperature, maximum operating temperature, maximum motor temperature, minimum operating voltage, maximum operating voltage, number of power failures, number of watchdog resets, number of motor start/stops, number of direction changes of motor, number movement onto mechanical end-stops, driving time versus torque histogram, maximum torque histogram for different position ranges, number of overload events, minimum and maximum end position displacements, supercap status, commissioning successful indicator, actuator has been powered in the field indicator, or actuator has been reconfigured in the field indicator.

13. The HVAC actuator of claim 9, wherein at least one of the non-volatile memory unit or the NFC circuit is integrated in the ASIC.

14. The HVAC actuator of claim 9, wherein the program code is configured to control the microprocessor to reject a write request received from the external communication device if the write request is directed to writing into the non-volatile memory unit a data value which does not differ from the data value presently stored in the non-volatile memory unit or if the write request exceeds a number of allowable write operations, the number of allowable write operations being increased over time up to a maximum number of write operations.

15. The HVAC actuator of claim 1, wherein the ASIC comprises an interface configured to connect to the digital circuit of the ASIC at least one of: a temperature sensor, a flow sensor, a pressure sensor, a hall sensor, an external further ASIC, arranged externally to the ASIC, an external microcontroller, arranged externally to the ASIC, or a supercap module, arranged externally to the ASIC.

16. The HVAC actuator of claim 15, wherein the digital circuit comprises a read/write memory unit accessible for the microprocessor, and the program code is configured to control the microprocessor to exchange data between the read/write memory unit and the external microcontroller via the interface.

17. The HVAC actuator of claim 1, wherein the interface comprises at least one of: a serial communication line interface or a parallel communication bus interface.

18. The HVAC actuator of claim 1, wherein the HVAC actuator comprises a printed circuit board, and the electric motor and the controller are arranged on the printed circuit board.

19. The HVAC actuator of claim 1, wherein the ASIC comprises a charge pump controller configured to provide power to the HVAC actuator.

20. An Application Specific Integrated Circuit, ASIC, for an HVAC actuator according to claim 1, the ASIC comprising an analog circuit and a digital circui,t the analog circuit of the ASIC being configured to generate a motor current for the electric motor of the HVAC actuator the digital circuit of the ASIC being configured to generate control signals for controlling the analog circuit, wherein the digital circuit of the ASIC comprises a motor control circuit, a microprocessor directing the motor control circuit, and a memory unit having stored therein program code configured to control the microprocessor.
